(19) United States
(12) Patent Application Publication
(10) Pub. No.: US 2006/0140680 A1
(43) Pub. Date: Jun. 29, 2006

(54) Feeding of toner

(76) Inventor: Mikael Hakansson, Malmo (SE)

Correspondence Address: YOUNG & THOMPSON, 745 SOUTH 23RD STREET, 2ND FLOOR, ARLINGTON, VA, 22202, US

(21) Appl. No.: 10/531,280

(22) PCT Filed: Oct. 14, 2003
(86) PCT No.: PCT/SE03/01591

§ 371 Date: Nov. 9, 2005

(30) Foreign Application Priority Data
Oct. 14, 2002 (SE) 0203034-4
Apr. 23, 2003 (SE) 0301190-5

(51) Int. Cl. G03G 15/08

(52) U.S. Cl. 399/258

(57) ABSTRACT

Device and method for feeding of toner powder to a manifold apparatus (1) comprising at least one toner container (2), which device (3) comprises at least one receptacle (4) for toner powder, a feeding device (5) and a delivery conduit (6) in communication with the receptacle (4). The invention is characterized in that the feeding device (5) is mechanical and that the delivery conduit (6) intended to be connected to the toner container (2) of the manifold apparatus (1), which toner container (2) is of optional design.

### FIELD OF APPLICATION

The present invention concerns feeding of colour powder, so called toner, by way of a conveying screw from an external receptacle to a toner cartridge existing in a manifold apparatus. The invention achieves a universal use with different types of apparatuses and exercises small influence on existing equipment.

### BACKGROUND OF INVENTION

Today there are a lot of different machines for different types of transcription, for example fax machines, printers and copying machines. In the following description the word “manifold apparatus” will be used for these types of machines. It should be understood that all types of machines with a toner are embraced with this word.

In such apparatus there is a container with the toner that constitutes the print on the sheet of paper. Generally, this container is a light non-permeable cartridge of plastics, which is exchanged for a filled one when the toner has run out. The amount of toner in such cartridge is relatively limited, which means that change of cartridges in apparatuses serving several users must be performed relatively often.

Different types of apparatuses, apparatuses of different manufacture and apparatuses of different models by the same manufacturer demands toner cartridges of different types specially adapted for respective apparatus. This causes that an office must have apparatus specific containers in stock, which of course takes up a great deal of space and locks capital.

Furthermore, there is also a certain problem to handle the empty containers, since these in some cases are to be sent back to the manufacturer for refilling. A problem with this procedure is that many users think that is it too work demanding and therefore throws the used cartridge in the garbage, which results in negative environmental influence since the cartridge consists of plastics and contains a remainder of toner.

One way to solve a least the problem with limited amount of toner, is to use a larger container or a so called “transport tank”.

The document U.S. Pat. No. 6,021,294 describes a device for feeding of toner to a printer or the like, which contains a toner box which in turn has two reservoirs for toner. A delivery line is connected to each reservoir, which lines are connected to toner transport containers. An extraction channel is connected to the toner box and ensures an underpressure in the box. By way of opening and closing valves, the underpressure transports the toner from the transport containers to the toner reservoirs. Level sensors detect the level of toner in the toner reservoirs to ensure that the toner levels in the toner reservoirs are not too low.

Thus, the document describes a container connection to toner cartridges in an apparatus, where each container contains a certain colour. The reason for this is that one wants to ensure that relatively large amounts of toner are accessible for different printing operations, where one printing operation might call for more toner of a certain colour than a subsequent operation. To feed the toner, underpressure is used by way of a blower, and arranged in an outlet from the cartridges. Therefore, the cartridges have to be modified so that they can be attached to the toner feeding hoses, and so that the air can circulate through the toner cartridges. If a leakage would arise somewhere along the transport path of the toner, the current of air would make it possible for the toner to spread inside the apparatus and the surrounding room.

This solution is therefore not generally applicable to any apparatus, since large operations have to be done in the apparatus. Moreover, the system will probably have to be adjusted and trimmed to prevent toner from flowing out through the air outlet and/or through other openings in the cartridges or in the apparatus, which otherwise cause's environmental problems. This also tells against applying this solution on any apparatus.

U.S. Pat. No. 4,945,956 also describes a similar solution for transport of toner from a transport container to a toner reservoir by way of a flexible line by way of underpressure created by a fan. Likewise; the problems according to the above can arise with toner flying about during a possible leakage. In addition a filter is arranged in the reservoir to prevent that the toner is sucked out through the air outlet. In this case, the reservoirs have to be modified so that the arrangement will work without environmental problems, which also tells against a more general solution.

From the documents that have come to hand, it can be seen that feeding of toner from larger transport containers to a copying machine or printer is known as such. None of the documents indicates expressly clearly that the transport containers are arranged outside the apparatus.

Nevertheless, none of the documents describes a, in an uncomplicated way, generally applicable solution for all types of apparatuses.

### BRIEF DESCRIPTION

The present invention intends so solve the above mentioned drawbacks by a device according to the patent claim 1, wherein a receptacle is connected to an optional toner container by way of a delivery conduit with mechanical feeding of toner from the receptacle of the device to the toner container.

By using a device according to the invention, one can in a simple and environment friendly way get away from apparatus specific toner packages. This problem is solved by an external, closed receptacle with toner, containing a larger amount than the cartridge itself, a conveying screw connected to the receptacle, as well as a delivery conduit connected to the conveying screw. The delivery conduit is further arranged with a sealing connection means to the toner cartridge of the apparatus. In this way, a closed system is achieved where no toner can leak out, at the same time as a minimal operation has to be done in the apparatus to connect the external receptacle. The above mentioned problem with dispersion of toner because of the air current used for transport is not found in the present invention.

Since the filling of toner is continuous, the loss that otherwise occurs with the conventional method is avoided. When a usual toner cartridge is exchanged, there is always a certain amount of unused toner left in the cartridge. By using a solution according to the invention, where the cartridge is replenished, this loss is minimised.

When using mechanic feeding of toner from a separate receptacle as in the present invention, the amount of toner flying about in the apparatus will not be as large as in for example the devices in the documents above, wherein the feeding is processed by way of air. The closed mechanic feeding system according to the invention also prevents toner from flying about in the air outside of the apparatus, and decreases the risk for toner flying about at a possible leakage. Inhalation of large amounts of toner can be dangerous.

A further advantage with the present invention is that future manifold apparatuses can be prepared for an installation of the present invention, i.e. that they are arranged with space to hold this, which causes less damage to the manifold apparatus.

Another advantage is that toner cartridges are prepared for connection of the present invention, i.e. that they already have a blind connection for the delivery conduit, as for example a piece of conduit or a screw tap which with a simple tool can be opened or removed so that a passage into the toner cartridge is achieved.

The invention provides for a device for feeding of toner powder to a manifold apparatus with a toner container, which device comprises at least one receptacle for toner powder, a feeding device in communication with the receptacle, and a delivery conduit. According to one aspect, the invention is characterized in that the feeding device is mechanical and that the delivery conduit is intended to be connected to the toner container of the manifold apparatus, which toner container is of optional design. According to another aspect, the invention is characterised in that the delivery conduit is intended to be connected to a communication path into the toner container, which communication path is opened in connection with an initial connection of the device to the manifold apparatus.

These and other aspects of, as well as advantages with the present invention will be evident from the detailed description and the enclosed drawings.

### SHORT DESCRIPTION THE DRAWINGS

In the detailed description of the present invention reference will be made to the enclosed drawings, wherein

FIG. 1 diagrammatically shows a connection of a device according to the invention to a manifold apparatus,

FIG. 2 shows an embodiment of the invention wherein a hose is connected to the receptacle for filling of toner into the receptacle,

FIG. 3 shows another embodiment of the invention wherein a bottle is connected to the receptacle,

FIG. 4 shows another embodiment of the invention where in a larger receptacle/drum is connected to the receptacle,

FIG. 5 shows yet another embodiment of the invention to fill the powder into the receptacle,

FIG. 6 shows an alternative feeding device,

FIG. 7 shows another alternative feeding device, and

FIG. 8 shows a third alternative feeding device.

### DETAILED DESCRIPTION OF THE EMBODIMENTS OF THE INVENTION

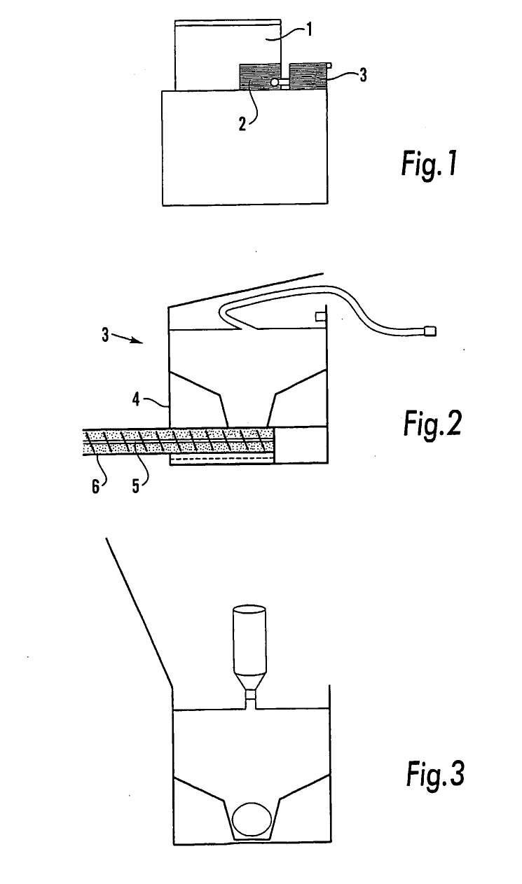

FIG. 1 shows a manifold apparatus (1) comprising a toner container/cartridge (2) of optional design, and a device (3) according to the invention.

FIG. 2 shows a device (3) comprising a receptacle (4) for toner and a feeding device (5) connected to this receptacle, as well as a delivery conduit (6). The storage volume of the receptacle is essentially larger than the volume of the toner cartridge (2). The feeding device (5) is mechanical and may consist of a conveying screw which is, for example, driven by a motor. By using a conveying screw a more continuous and even feeding of toner into the toner cartridge (2) is achieved.

According to one embodiment of the invention, the toner receptacle (4) can, when it needs to be refilled with new toner, easily be replaced with another new similar one which is connected to the feeding device.

In FIG. 3 another embodiment of the invention is shown, wherein a PET-bottle is used to refill the receptacle (4). It is possible that one may get money in return for bottles at the supplier, and that an exchange for a filled bottle can be done by the supplier. The bottle is suitably made by a protective foil on the bottle neck, which is broken not until the bottle is connected to the receptacle. A PET-bottle contains considerably more than the existing toner cartridges in the apparatuses. This also leads to a lower price per litre toner.

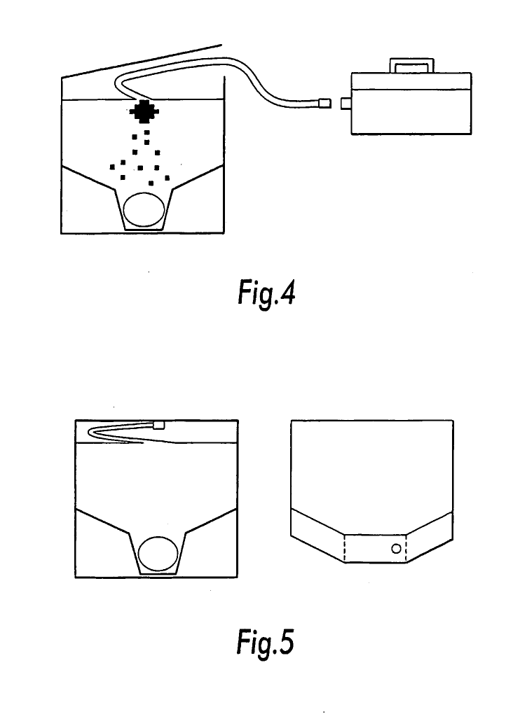

FIG. 4 shows yet another embodiment of the invention, where in a larger receptacle, for example a drum of approximately five litres, is used to fill the receptacle (4) via a hose to the receptacle. When one wishes to refill the receptacle (4) toner is poured from the drum and further into the receptacle.

FIG. 5 shows another embodiment of the invention to refill powder into the receptacle. A suitably foiled carton with the same shape as the interior of the receptacle is filled with toner and placed inside the receptacle. Alternatively, the foil can be substituted by a separate inner bag inside the carton.

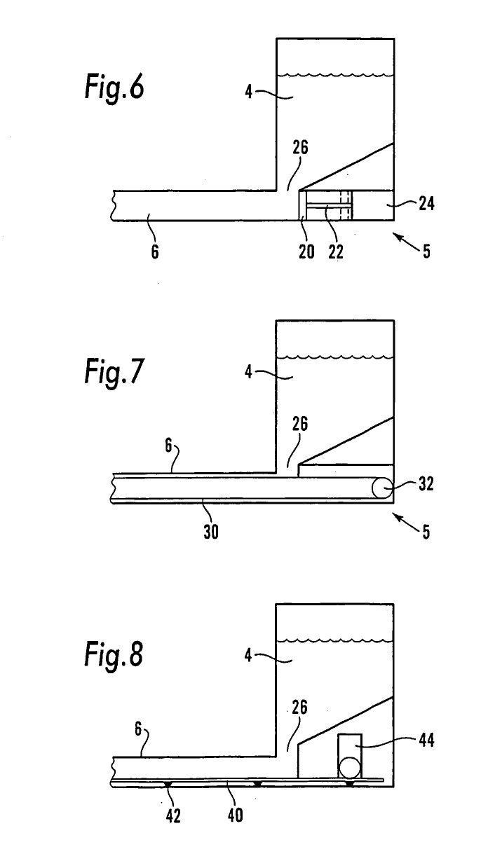

The embodiment shown in FIG. 6 comprises a receptacle (4) for toner. The receptacle is arranged to a feeding device (5) and a delivery conduit (6). The delivery conduit (6) is connected to a toner container/toner cartridge (not shown) in a manifold apparatus such as a copying machine or a larger printer.

In the embodiment according to FIG. 6 the feeding device (5) comprises a piston (20) and a piston rod (22) arranged for reciprocating motion by an operating device (24). The design of the piston (20) mainly corresponds to the shape of the delivery conduit (6). A passage (26) is arranged between the toner receptacle (4) and the delivery conduit (6), so that toner material continuously can be supplied to the delivery conduit (6) by way of gravity. In use, the feeding device (5) feeds toner into the delivery conduit (6) by the reciprocating movement, wherein toner powder falls down through the passage to the delivery conduit (6) at the returning movement.

FIG. 7 shows another alternative feeding device (5) where it is constituted by a conveyer belt (30) arranged around two rolls or wheels or other operating and control elements for an operating belt, where only the rear wheel (32) is shown. The front wheel is arranged in the delivery conduit (6) in the vicinity of the toner cartridge (2). The rear wheel is arranged to a suitable operating device (not shown) capable of rotating the wheel. The conveyer belt (30) can be made of for example rubber, plastics and may be reinforced to minimise stretching of the belt (30). It can further be arranged with elevations, such as transversal strips to facilitate the feeding of toner material from the receptacle (4) to the toner cartridge (2).

FIG. 8 shows yet another alternative of feeding device (5) where this is provided by a plate (40) or the like extending from the passage (26) to the toner cartridge. The plate (40) is suspended on elastic resilient devices (42), so that it is vertically and horizontally moveable. An operating device (44) is connected to the plate (40) capable of achieving an oscillating movement of the plate (40) with a certain frequency. The operating device (44) can for example be an electric motor with an oval wheel bearing on a plate. In this way, toner material falling through the opening (24) can be “shaken” up to the toner cartridge (2).

A communication path is created in a suitable way, for example a hole may be drilled through the exterior housing of the apparatus (1) and further through the toner cartridge (2). The delivery conduit (6) of the device is connected to the apparatus and thereby provides a closed communication between the receptacle (4) and the toner cartridge (2). Each time the toner level in the cartridge (2) is so low that replenishing of toner is desirable, the feeding mechanism (5) is activated by for example an activating device/switch starting the motor of the feeding mechanism. Accordingly, the very same toner cartridge in the apparatus is used the whole time, and is replenished from the receptacle.

Suitably, the toner cartridges (2) are designed with possibilities of connection for the delivery conduit (6) even at the time of manufacturing of these cartridges, to simplify the connection of the device according to the invention to the manifold apparatus. The connection can be a screw tap with a removable lid, to which tap the delivery conduit can be connected after the lid has been removed, or a threaded sleeve to which the end of the delivery conduit is threaded or similar types of connections. Furthermore, the manifold apparatus can, when manufactured, be adapted so that the device according to the invention can be held inside the apparatus, where it makes part as an integrated detail of the manifold apparatus.

In a preferred embodiment, the activating device is connected to a timer, which time interval is adapted to fill the cartridge (2) to approximately 80% to minimise the risk for overfilling the cartridge (2). The timer is preferably set at installation and should not be accessible for users.

If the apparatus (1) is provided with an indicator for low toner level, it may be connected to the feeding device (5). The device is suitably located in the vicinity of the manifold apparatus and preferably outside the apparatus.

The toner transporting parts of the system are preferably made of a light non-permeable material.

The device according to the invention can easily be assembled to almost all apparatuses with a toner cartridge. Toner particles flying about in the air and in the apparatus are avoided by this mechanical feeding.

The embodiments shown in the drawings and performed in the description should not be considered limiting, but only as example.

1. Device for feeding of toner powder to a manifold apparatus (1) comprising at least one toner container (2), which device (3) comprises at least one receptacle (4) for toner powder, a feeding device (5) and a delivery conduit (6) in communication with the receptacle (4), characterized in that the feeding device (5) is mechanical and that the delivery conduit (6) is arranged with a non-apparatus adapted connection means and intended to be connected to the toner container (2) of the manifold apparatus (1), which toner container (2) is of optional design.

2. Device according to claim 1, characterized in that the delivery conduit (6) is intended to be connected to a communication path into the toner container (2), which communication path is opened at an initial connection of the device to the manifold apparatus (1).

3. Device according to claim 1 characterized in that the feeding device (5) comprises a timer function intended to control the feeding device.

4. Device according to claim 1 characterized in that the feeding device (5) is provided by a conveying screw.

5. Device according to claim 1, characterized in that the feeding device (5) is a piston assembly (20, 22) arranged for reciprocating motion for feeding of toner powder to the toner container (2).

6. Device according to claim 1, characterized in that the feeding device (5) is a conveyor belt (30) rotatable around at least two rollers (32), an operating device capable of rotating the belt for feeding of toner powder to the toner container (2).

7. Device according to claim 1, characterized in that the feeding device (5) is a vibrating device (40, 42, 44) capable of feeding toner powder to the toner container (2) by an oscillating movement.

8. Device according to claim 1 characterized in that the receptacle (4) is exchangeable.

9. Device according to claim 1 characterized in that an exchangeable PET-bottle is connected to the receptacle (4) for refilling of the receptacle.

10. Device according to claim 1 characterized in that an exchangeable foiled carton is placed in the receptacle (4) for refilling of the receptacle.

11. Device according to claim 1 characterized in that the receptacle (4) is arranged outside the manifold apparatus (1).

12. Method for feeding of toner powder from a device (3) to a manifold apparatus (1) comprising at least one toner container (2), which device (3) comprises at least one receptacle (4) for toner powder, a feeding device (5) and a delivery conduit (6) in communication with the receptacle, characterized in that the delivery conduit (6), which is arranged with a non-apparatus adapted connection means, is connected to a communication path into the toner container (2), which communication path is opened in connection with an initial connection of the device (3) to the manifold apparatus (1).

13. Toner container designed with devices for connection of a device according to claim 1.
